(19) United States
(12) Patent Application Publication
(10) Pub. No.: US 2003/0193953 A1
(43) Pub. Date: Oct. 16, 2003

(54) Automatic provisioning of ATM connections

(75) Inventors: Nir Drort, Rehovol (IL); Joshua Klipper, Netanya (IL); David Rouchbach, Natanya (IL)

Correspondence Address: Fogg Slifer Polglaze Leffert & Jay, P.A., P.O. Box 581009, Minneapolis, MN, 55458-1009, US

(73) Assignee: ADC Telecommunications Isreal Ltd.

(21) Appl. No.: 10/118,879

(22) Filed: Apr. 9, 2002

(51) Int. Cl. H04L 12/28; H04J 3/16; H04M 11/00

(52) U.S. Cl. 370/395.1; 370/466; 379/93.04

(57) ABSTRACT

A method for automatic provisioning of ATM traffic is provided. The method includes receiving upstream asynchronous transfer mode (ATM) data from customer premises equipment, detecting the port number at which the upstream ATM data is received, and reading a first virtual path identifier (VPI) number of the upstream ATM data from the header information. The method further includes acquiring a new VPI number for the upstream ATM traffic based on the receiving port number and the first VPI number, attaching the new VPI number to the upstream ATM traffic, and directly mapping the ATM traffic onto one or more TDM transmission lines.

### TECHNICAL FIELD

The present invention relates generally to the field of telecommunications and, in particular, to automatic provisioning of asynchronous transfer mode connections.

### BACKGROUND

Digital Subscriber Line (DSL) is a generic name for a family of evolving digital services to be provided by local telephone companies to their local subscribers. DSL includes but is not limited to Single Pair Symmetrical Services (SDSL), Asymmetric Digital Subscriber Line (ADSL), High Bit Rate Digital Subscriber Line (HDSL), and single-pair, high-bit-rate digital subscriber line (G.SHDSL). These services provide high-speed connections over existing copper wires to carry conventional telephone traffic. These services use various modulation schemes and other techniques to allow the data to be transmitted over the existing copper lines at higher speeds. In addition to data, some of these DSL technologies allow multiple phone lines to share one physical line thus increasing the capacity of the system without the need to install additional copper connections between the customer and the network.

Unfortunately DSL voice traffic is not directly compatible with conventional equipment in the Public Switched Telephone Network (PSTN). For example, DSL voice traffic conventionally is incorporated in Asynchronous Transfer Mode (ATM) packets or cells. ATM is a cell-based technology that supports voice, video, and data over a wide range of transmission speeds. One of the benefits of ATM is its ability to optimize wide-area bandwidth while accommodating the characteristics of various traffic types, with multiple classes of service. This is different from the Time Division Multiplexing (TDM) format associated with the PSTN. In order to transmit the data additional equipment is added to the PSTN network such as ATM switches and ATM multiplexers providing ATM traffic management such as policing. As a result, the cost of providing DSL solutions on a PSTN network is expensive and inhibits the ability of service providers to introduce new subscribers in a cost effective manner. U.S. patent application entitled “Integrated ADSL Interface with TDM Mapping” (Ser. No. 09/539,262) and commonly assigned to ADC Telecommunications, Inc. offers one way to provide broadband services to new subscribers without the use of an expensive ATM infrastructure.

Conventionally the method of establishing an asynchronous transfer mode (ATM) connection in Digital Subscriber Line (DSL) deployments, between customer premises equipment and the edge network (digital loop carrier (DLC), Digital Subscriber Line Access Multiplexer (DSLAM), or the like), is by using permanent virtual circuits (PVCs). PVC based connections rely on network management and are performed manually via a time consuming procedure that requires significant effort and careful planning by network managers. Software within the management system or embedded in the network provisions each PVC individually. Typically this is a large piece of software that handles the database. It creates the PVC from source to destination e.g. from the subscriber side up to the network side. In order to perform cross connects or other functions the software has to handle the database, update the database, determine if a connection already exists and other management functions. In Access or DSLAM systems an ATM card is included and the ATM card handles the management. A drawback in providing mass deployment of DSL service in an access network is simple ATM connection provisioning procedures. In particular, provisioning procedures in systems that do not employ conventional ATM infrastructures.

For the reasons stated above, and for other reasons stated below which will become apparent to those skilled in the art upon reading and understanding the present specification, there is a need in the art for improvements in provisioning network connections.

### SUMMARY

The above-mentioned problems with provisioning procedures in access networks and other problems are addressed by embodiments of the present invention and will be understood by reading and studying the following specification.

In one embodiment, a digital subscriber line interface card is provided. The card includes a digital subscriber line interface adapted to receive asynchronous transfer mode traffic from one or more digital subscriber lines, and a translation device coupled to the digital subscriber line interface wherein the translation device is programmed to cross connect customer premises equipment to a network. The translation device cross connects customer premises equipment based on the physical port number traffic is received at and the number of virtual path identifiers assigned to the customer premises equipment. The card further includes an inverse multiplexer adapted to receive and map the asynchronous transfer mode traffic directly onto one or more time division multiplex transmission lines.

In one embodiment, a method for automatic provisioning ATM traffic is provided. The method includes receiving upstream asynchronous transfer mode (ATM) data from customer premises equipment, detecting the port number at which the upstream ATM data is received, and reading a first virtual path identifier (VPI) number of the upstream ATM data from the header information. The method further includes acquiring a new VPI number for the upstream ATM traffic based on the receiving port number and the first VPI number, attaching the new VPI number to the upstream ATM traffic, and directly mapping the ATM traffic onto one or more TDM transmission lines.

### BRIEF DESCRIPTION OF THE DRAWINGS

FIG. 1 is a block diagram of an illustrative embodiment of an access network that provides digital subscriber line access for subscribers using a TDM infrastructure according to the teachings of the present invention.

FIG. 2 is a block diagram of an illustrative embodiment of an ADSL on TDM Interface Card providing automatic provisioning of ATM connections according to the teachings of the present invention.

FIG. 3 is a block diagram of one embodiment of an interface between subscribers and a translation device of an ADSL on TDM Interface Card providing automatic provisioning of ATM connections according to the teachings of the present invention.

FIG. 4 is a flow chart of one embodiment of a method of static provisioning permanent virtual circuits according to the teachings of the present invention.

FIG. 5 is a flow chart for an embodiment of a method of automatic provisioning according to the teachings of the present invention.

FIG. 6 is a flow chart for another embodiment of a method for automatic provisioning according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide improvements in provisioning network connections by providing a system and method for automatic provisioning of permanent virtual circuits (PVCs). The PVCs are provisioned transparently through a translation device from the customer or subscriber side to the network side in systems that provide broadband services to subscribers without the need for an expensive asynchronous transfer mode (ATM) infrastructure. The result is automatic remapping of the VPIs to the network side without the need for individually provisioning the PVCs.

In one embodiment, the present invention provides automatic remapping of VPIs to the network side without individually provisioning the PVCs in an access network as discussed in copending, commonly assigned U.S. patent application Ser. No. 09/539,262 entitled “Integrated ADSL Interface with TDM Mapping”, filed Mar. 30, 2000, and incorporated herein by reference as if fully set forth (hereinafter referred to as the '262 application).

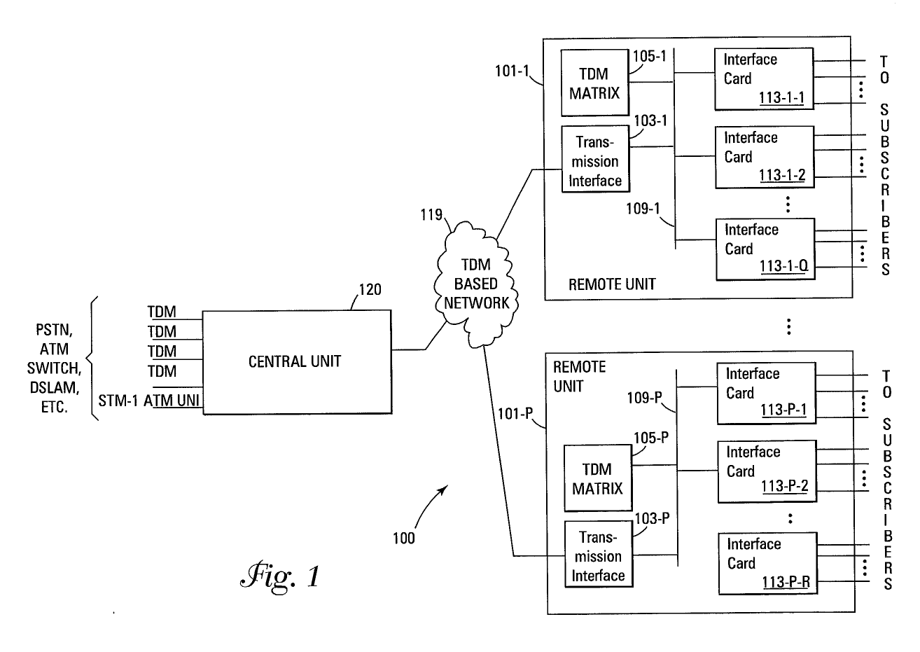

FIG. 1 is a block diagram of an illustrative embodiment of an access network that provides digital subscriber line access for subscribers using a TDM infrastructure, indicated generally at 100, according to the teachings of the present invention.

The access network 100 includes a central unit 120 coupled to a TDM-based network 119 and a plurality of remote units 101-1, . . . , 101-P also coupled to the TDM based network 119. Remote units 101-1, . . . , 101-M are each configured to receive analog and digital data, from a plurality of subscribers, via one or more of Asymmetric Digital Subscriber Line (ADSL), Plain Old Telephone Service (POTS), and Integrated Service Digital Network (ISDN). Data is received from a number of subscriber devices such as telephones, facsimile machines, personal computers (PCs), televisions, modems and the like. ADSL, POTS and ISDN traffic is also received by central unit 120 and routed through TDM-based network 119 for transmission by remote units 101-1, . . . , 101-P to a plurality of subscribers and subscriber devices. Data is received from a variety of sources to include the telephone network, ATM switch, DSLAM, internet, cable television, modems, facsimile machines and the like.

In one embodiment, access network 100 is a Digital Loop Carrier (DLC) system or platform which directly maps ADSLs to TDM transmission lines in the remote unit then transmits ADSL, ISDN and POTS traffic to the Public Switched Telephone Network (PSTN), an Asynchronous Transfer Mode (ATM) switch, a Digital Subscriber Line Access Module (DSLAM) or other network which is capable of performing ATM processing.

TDM-based network 119 represents one or more of a TDM network, an SDH ring, a SONET ring or other appropriate network. The TDM-based network 119 is also coupled to central unit 120 for further transmission to the PSTN, ATM switch, DSLAM or other ATM processing network.

Remote units 101-1, . . . , 101-P are each constructed in a similar manner. Thus for simplicity, only remote unit 101-1 is described in detail. Remote unit 101-1 includes subscriber interface cards 113-1-1, . . . , 113-1-Q, a TDM matrix or switching card 105-1 and a transmission interface device 103-1 which are all coupled to a time division multiplex bus 109-1. Interface cards 113-1 act as an interface between a plurality of subscribers and TDM-based network 119. Remote unit 101-1 includes any combination of subscriber interface cards 113-1-1, . . . , 113-1-Q, e.g., analog and digital interface cards such as POTS interface cards, ISDN interface cards, ADSL interface cards and the like. Subscriber interface cards 113-1 are coupled between the subscriber premises and a TDM transmission interface device 103-1 via TDM bus 109-1. Each ADSL interface card 113-1 directly maps ATM traffic from subscriber's ADSL lines onto TDM bus 109-1. Directly mapping the ATM traffic from the ADSL lines to TDM transmission lines does not include ATM processing such as ATM switching, assigning traffic descriptors for each connection, policing incoming traffic to insure that it meets its assigned or agreed to bandwidth requirements and the like.

In one embodiment, remote unit 101-1 includes one or more subscriber interface cards 113-1 such as ADSL interface cards, POTS interface cards, ISDN interface cards, or the like. It is understood that remote units 101-1, . . . , 101-P include any number of ADSL, POTS, ISDN, or the like, subscriber interface cards 113-1-1, . . . , 113-P-R in any appropriate combination.

Transmission interface devices 103-1 include any one of an optical transmission interface device, a copper wire transmission interface device, an HDSL transmission interface device or the like.

E1 transmission lines are used outside of North America and Japan and supply 32 channels at 2.048 Mbps. T1 transmission lines are mainly used in North America and supply 24 channels at 1.544 Mbps. It is understood, when referring to E1, that T1 is also included or when referring to T1, E1 is included.

In operation, access network 100 is configured to provide ADSL services in a TDM network without costly ATM equipment or the need for ATM processing. In the upstream direction, ADSL, ISDN and POTS traffic is generated by subscriber devices at subscribers premise, such as telephone, facsimile, personal computer, and television. Subscriber interface cards 113-1 of remote units 101-1, . . . , 101-P receive the ADSL, ISDN and POTS traffic and directly map the data onto TDM transmission lines for transport to TDM-based network 119. ADSL, ISDN and POTS traffic is transported as TDM traffic. TDM-based network 119 receives ADSL, ISDN and POTS traffic from a number of remote units 101-1, . . . , 101-P and transmits the ADSL, ISDN and POTS traffic as TDM traffic to a central unit such as central unit 120. Central unit 120 receives the traffic and optionally transmits ATM traffic via a single ATM pipeline or user network interface after ATM processing by ATM processor and UNI card or transmits the ATM traffic as TDM traffic via TDM lines e.g. E1s or T1s. The ADSL, ISDN and POTS traffic is transmitted to the PSTN, ATM switch, DSLAM or other appropriate ATM network for ATM processing, if required. Access Network 100 operates in a reverse manner in the downstream direction. Advantageously, ADSL services are integrated into a TDM network without an ATM infrastructure.

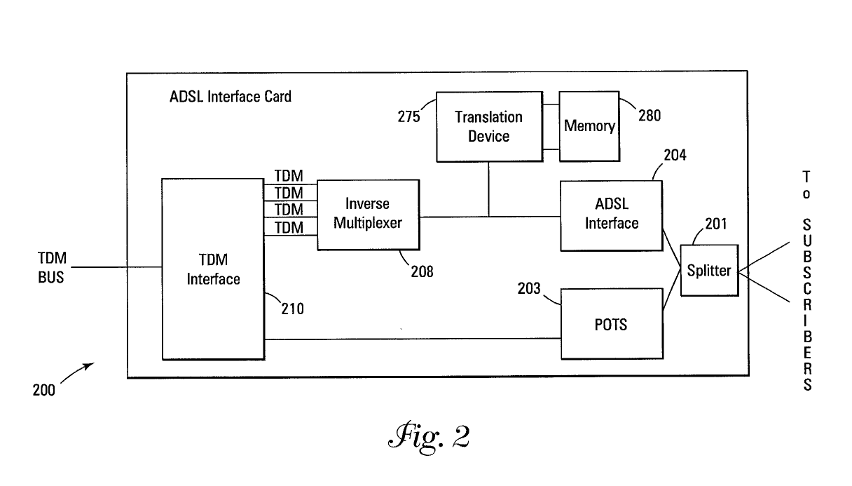

FIG. 2 is a block diagram of an illustrative embodiment of an ADSL on TDM Interface Card providing automatic provisioning of ATM connections, indicated generally at 200, according to the teachings of the present invention. In one embodiment, ADSL line card 200 directly maps ATM traffic from multiple ADSL interfaces terminated on a single integrated card to several time division multiplex (TDM) lines, e.g. T1 or E1 lines or combines all of the interfaces on the same card to a single T1/E1 for transmission back towards the ATM switch or ATM access concentrator as described in the '262 application. Interface card 200 directly maps ATM traffic without the need for performing ATM processing.

ADSL interface card 200 includes a splitter 201 coupled to an ADSL interface device 204 and a POTS circuit 203. Data received on ADSL lines from subscribers is separated by splitter 201 into ATM data and POTS data. POTS data is transmitted to the POTS circuit 203 and then to the TDM interface 210 where it is joined with the ATM data to be transmitted as TDM traffic.

ATM data is received by ADSL interface device 204 and based on the amount and type of ATM data (e.g. high, low, medium bandwidth) it is determined whether or not a translation header is required to transport the data. Data requiring a translation header is transmitted to translation device 275 for assignment.

ADSL interface card 200 operates in low, medium and high bandwidth modes.

In the medium bandwidth mode, moderate bandwidth ATM data (e.g., ADSL services requiring less than approximately 1.544 Mbps for T1 and less than approximately 2.048 for E1) is received by ADSL interface device 204 from a plurality of ADSLs and transmitted to inverse multiplexer 208. The ATM data is directly mapped onto a plurality of TDM transmission lines, e.g. T1 or E1, on a one to one basis. For example 3 moderate ADSLs are directly mapped onto 3 μl or T1 lines. In one embodiment, ADSL card 200 accommodates up to 4 ADSLs to be directly mapped onto 4 μl or T1 lines. Inverse multiplexer/TDM physical interface device 208 performs ATM inverse multiplexing and ATM TDM physical interface and will be referred to in this application as an inverse multiplexer. The ATM data is then transmitted to TDM interface 210 via the E1 or T1 transmission lines for further transmission to a TDM based network.

In the high bandwidth mode, high bandwidth ATM data (i.e. video) is received by ADSL interface device 204 from a plurality of ADSLs and transmitted to inverse multiplexer 208. The ATM data is then directly mapped onto a plurality of E1 or T1 transmission lines where up to four E1s or T1s operate as a single high bandwidth pipe. Inverse multiplexer 208 allows the E1s or T1s to be shared as a single pipe with approximately 8 Mbps of bandwidth. The ATM data is then transmitted to TDM interface 210 via the E1 or T1 transmission lines for further transmission to a TDM based network.

In the low bandwidth mode, low bandwidth ATM data (e.g., ADSL services for the internet where a few hundred kilobits are required) is received by the ADSL interface device 204 from a plurality of ADSLs and requires header translation and VPI mapping. The data is transmitted to translation device 275 and automatic provisioning of the ATM connections is performed. In one embodiment, translation device 275 includes a storage device 280 such as a random access memory or the like. In one embodiment, storage device 280 is integral to translation device 275. In an alternate embodiment, storage device 280 is coupled to translation device 275. The process of automatic provisioning will be further described below. The ATM data is then directly mapped onto a single transmission line, e.g. E1 or T1 line by inverse multiplexer/TDM physical interface device 208 and transmitted to TDM interface 210. The data is then transmitted to a TDM bus for further transmission to a TDM based network.

ADSL interface card 200 also receives low, moderate and high bandwidth data from a TDM-based network on TDM transmission lines and transmits the data to subscribers via ADSLs. The data is received at TDM interface 210 from a TDM bus. The data is split into ATM and POTS traffic. POTS traffic is transmitted to POTS circuit 203 and then to splitter 201 for transmission to subscribers. ATM traffic is transmitted to inverse multiplexer 208 and directly mapped onto ADSLs for transmission to subscribers. ATM data directly mapped onto ADSLs is transmitted to ADSL interface device 204 and to splitter 201 for transmission to designated subscribers.

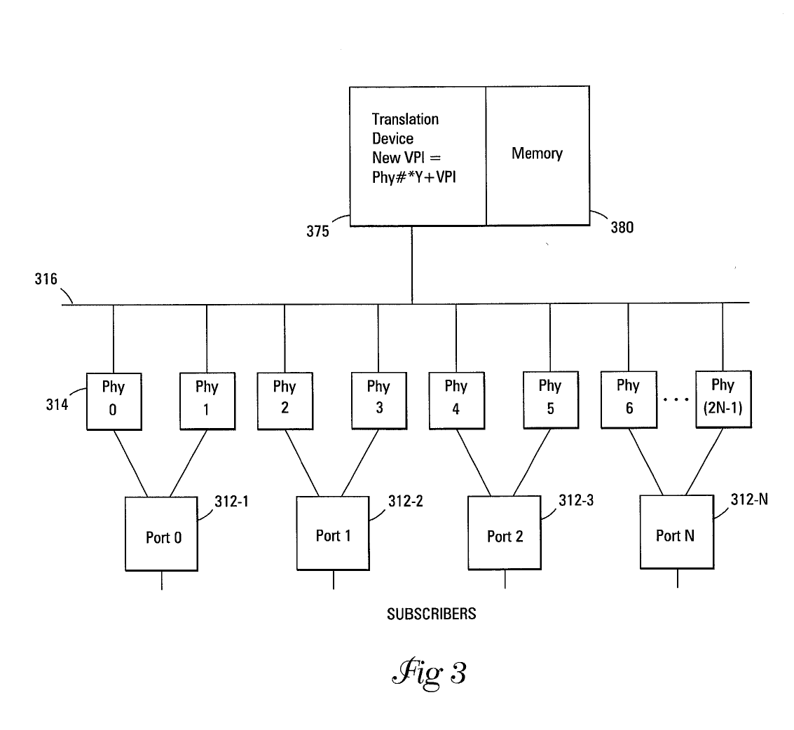

FIG. 3 is a block diagram of one embodiment of an interface between subscribers and a translation device of an ADSL on TDM Interface Card providing automatic provisioning of ATM connections, shown generally at 300, according to the teachings of the present invention. Each ADSL interface is assigned a predefined number of VPIs and embodiments of the present invention automatically provision and remap the connection between customer premises equipment toward an ATM switch or ATM Access Concentrator.

The interface between subscribers and a translation device 375 includes a plurality of ports 312-1 to 312-N. Each ADSL port 312-1 to 312-N has two ATM PHYs 314 connected via a universal test and operations physical interface for ATM (UTOPIA) bus 316 to translation device 375. Translation device 375 performs a virtual path (VP) cross connect function. For example, a subscriber connected to ADSL port 0, 312-1, is mapped on the ADSL card to ADSL PHY number 0, in single latency mode or to ADSL PHY number 0 and ADSL PHY number 1 in dual latency mode. If the subscriber's CPE, that is connected to ADSL port 0, has been provisioned with VPI=0, VCI=35 in the interleave channel in dual latency mode, those connection parameters will be remapped to VPI=8, VCI=35 whenever 8 VPIs are assigned to each subscriber. In the case where another subscriber is connected to ADSL port 2 (PHY number 4) on the same card with the same VPI & VCI pair (0 and 35, respectively) its VPI and VCI pair will be mapped to VPI=32, VCI=35.

In one embodiment, translation device 375 uses the following equation to create the new VPI.

New_VPI=PHY_number*Y+VPI

Y is a constant that is based on the VPI numbers that are assigned to each subscriber. In one embodiment, for applications where the subscribers are provided VPIs between 0 and 7, Y is equal to 8. In another embodiment, for applications where the subscribers are provided VPIs between 0 and 15, Y is equal to 16. Translation device 375 is application specific and code used by translation device 375 is written based on the specific application, for example presetting the value of Y for different manufacturers of subscriber equipment based on the VPIs assigned to their equipment. In one embodiment, translation device 375 is an application specific integrated circuit.

In one embodiment, translation device 375 stores the new VPIs in a memory or look-up table of storage device 380. In one embodiment, storage device 380 is integral with translation device 375. In another embodiment, storage device 380 is separate from and coupled to translation device 375. In one embodiment, storage device 380 is a random access memory or the like.

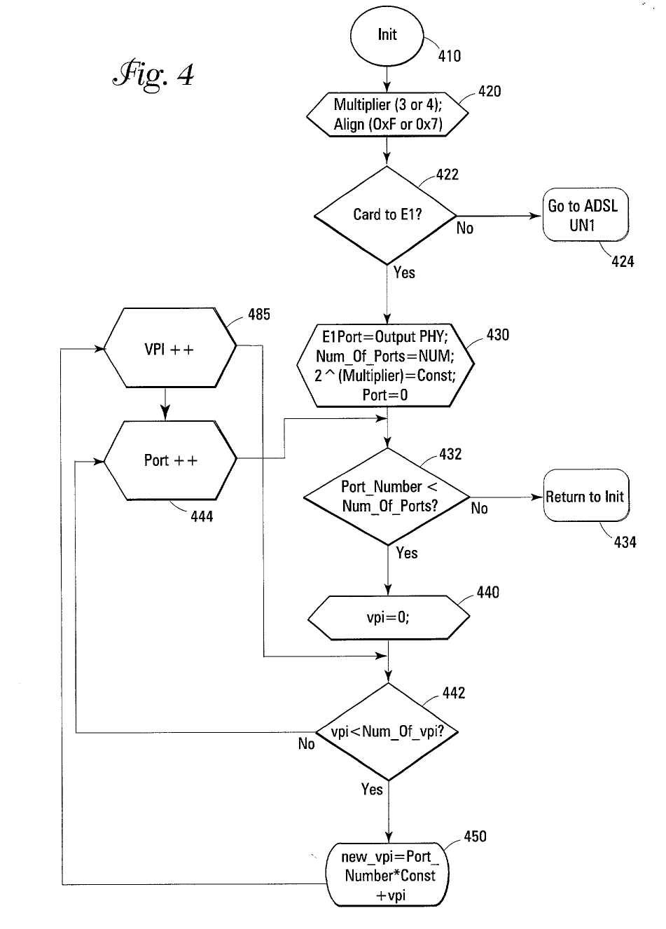

During system initialization a static provisioning of permanent virtual circuits is performed by translation device 375. Each port and physical port is provisioned for the range of VPIs known to the translation device 375. Translation device 375 performs an automatic combination, calculating a new VPI for every PHY port/VPI combination. Translation device 375 looks at the physical port and the range of VPIs and it runs a program that multiplies the VPI by a certain number and adds it to the port number. As a result it accepts, it receives a certain number that is the entry to its memory table. FIG. 4 is a flow chart of one embodiment of a method of static provisioning permanent virtual circuits according to the teachings of the present invention.

The method begins at block 410 and the system initializes. The method proceeds to block 420 and initializes multiplier and mask values according to the number of VPI's that the card should support. In one embodiment the card supports 8 VPI's (VPI=0 through 7) the multiplier should be 3 and the align value 0×7. In another embodiment, the card supports 16 VPI's (VPI=0 to 15) the multiplier value should be 4 and the align value will be 0×F. The align value isolates the real VPI when setting up the downstream connection so whenever a cell arrives in the downstream direction the real VPI will be found in the lookup table.

The method proceeds to block 422 and determines if there is an ADSL to E1 interface card in the system if yes the method proceeds to 430 and defines some of the interface parameters. In one embodiment, the interface parameters include for example how many ports are in the system and what number of VPIs are available for this specific application. In this embodiment, the number of VPIs is a constant that is predetermined for the specific application. For example some equipment manufacturers use VPIs between 0 and 7 and the constant is set at 8. In other embodiments, equipment manufacturers use VPIs between 7 and 15 or 0 and 15 and for each of those the constant is set at 16. Further in this embodiment, the ports are numbered sequentially beginning with 0.

If at block 422 there are no ADSL to E1 interface cards in the system the method proceeds to block 424 and the data proceeds toward the ADSL UNI without the need for header translation or VPI remapping.

At block 432 the method determines if the current port number is less than the total number of ports for this application. When the port number received at block 432 exceeds the number of ports for this application the routine proceeds to block 434 and returns to block 410. In all other instances the method proceeds to block 440 and the VPI is set at 0 for the first instance. The method proceeds to block 442 and the VPI is compared to the number of VPIs for this application, which was set as a constant at block 430. When the VPI number received at block 442 is less than the constant as defined at block 430 the method proceeds to block 450 and a new VPI is calculated based on the port number and the value of the multiplier as determined at step 420. The method proceeds to block 485 where the VPI number is incrementally advanced to the next VPI and the routine is repeated until all VPIs for the first port have been calculated. At block 442 when the VPI number has been advanced to a number that exceeds the number of VPIs for this application the method proceeds to block 444. At block 444 the port number is incrementally advanced to the next port and the routine is repeated for all of the VPIs for this port. The routine repeats until all the port and VPI combinations have been mapped to new VPIs.

This routine produces a unique number for every user cell by a combination of the cell's VPI and the port number upon which the cell arrived. In one embodiment, the new VPI numbers based on the port and VPI number combinations are stored in a look-up table of a storage device such as storage devices 280 and 380 of FIGS. 2 and 3, respectively.

In one embodiment, LCI, a pointer to memory is used to locate the new VPI for storage and retrieval in a memory table. In one embodiment, the LCI includes the original VPI and port number. In one embodiment, the LCI is determined by the following code:

LCI=VPI<<4|port

Where the VPI value received in the ATM header cell is shifted to the left by 4 bits. The bits that are shifted out through the high-order bit are lost and the next 4 bits are the port number at which the traffic arrived.

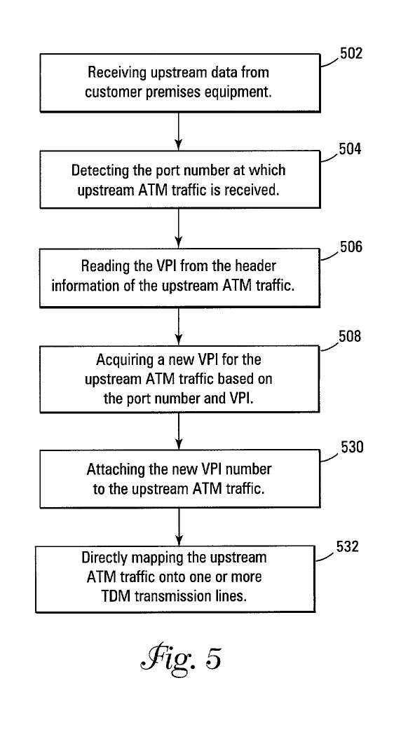

FIG. 5 is a flow chart for one embodiment of a method for automatic provisioning according to the teachings of the present invention. The method begins at block 502 and an ADSL subscriber interface card such as card 131-1 or card 200 of FIGS. 1 and 2, respectively, receives upstream data from customer premises equipment. The method proceeds to block 504 and detects the port number at which upstream ATM traffic is received. The method proceeds to 506 and reads the VPI from the header information of the upstream ATM traffic and proceeds to block 508. At block 508 the method acquires a new VPI number for the upstream ATM traffic based on the port number and the VPI extracted from the header information.

In one embodiment, acquiring a new VPI number comprises calculating the new VPI based on the received VPI, receiving port number and a pre-determined constant. The pre-determined constant is set in the translation device based on the maximum number of VPIs required for this customer's application. For example some manufacturer's equipment are assigned VPIs between 0 and 7 or 0 and 15, etc. and require different constants to assign new unique VPIs for each port/VPI combination. In one embodiment, the constant is preprogrammed into an algorithm for calculating the new VPIs.

In another embodiment, acquiring a new VPI number comprises retrieving a new VPI number from a look-up table based on the received VPI and receiving port number. In one embodiment, the look-up table is established when the system initializes and each port and VPI combination is assigned a new and unique VPI number that is stored in the look-up table. As a result the new VPIs are assigned statically.

The method proceeds to block 530 and attaches the new VPI number to the upstream ATM traffic by replacing the current VPI with the new VPI in the header of the upstream traffic. The method proceeds to block 532 and transmits the upstream ATM traffic over one or more TDM transmission lines.

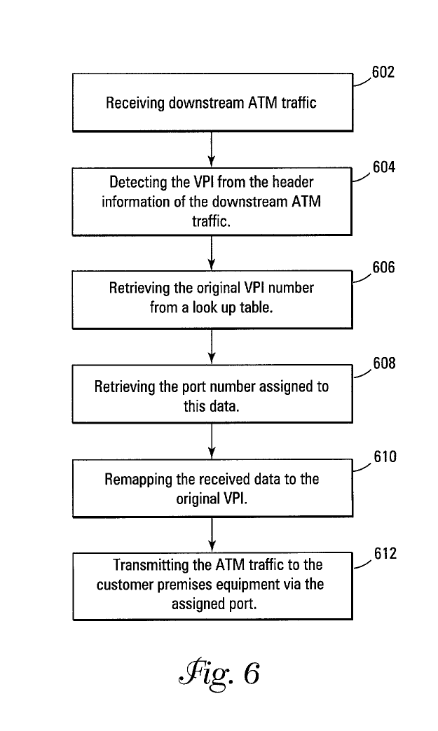

FIG. 6 is a flow chart for another embodiment of a method for automatic provisioning according to the teachings of the present invention. The method begins at block 602 and receives downstream ATM traffic from one or more TDM transmission lines and proceeds to block 604. At block 604 the method detects the downstream VPI from the header information of the downstream ATM traffic proceeds to block 606 and retrieves the original VPI number from a look-up table. The method proceeds to block 608 and retrieves the port number associated with the received VPI number. The method proceeds to block 610 and remaps the received data to the original VPI. In one embodiment, the method further includes aligning the VPI based on the configuration of the header for example in a system using only 7 of the eight bits in a VPI field (0×0007) the VPI is aligned so that the correct VPI port number combination is obtained. The method proceeds to block 612 and transmits the ATM traffic to the designated customer premises equipment via the assigned port.

Without the ATM layer one embodiment for addressing simple provisioning is to divide the VPI field from an ATM header cell into two separate fields. This can be varied for different types of users. For example, in one embodiment, for an infrequent user:

1—physical ADSL port number (4 bits as per the number of ADSL PHY on the card).

2—VPI used for the connections (the lowest 3 bits in the ATM header as per the possible number of assigned VPIs for each port).

In situations where the number of VPIs for each port exceeds 3 bits the lowest 4 bits in the ATM header are used.

In one embodiment, the downstream VPI=(port<<4)|vpi. In another embodiment, the downstream VPI=(port<<3)|vpi. The upstream VPI is equal to the downstream VPI.

The bits that are contained in the ATM header provide a huge space of virtual memory. The translation device enables a reduction in the amount of memory required and performs VPI cross connect or VPI remapping with a fraction of the memory required for an ATM management device.

This approach simplifies the ADSL card software dramatically, since it eliminates the need to manage connection databases, which further eliminates any excess communication messages within the remote unit and between the central and remote units. As an ATM card is not required at the central and remote units.

The method of automatic provisioning of ATM connections is implemented using an algorithm. In one embodiment, the algorithm consists of the following:

if ((CardType == CardToE1_E) || (CardType == AdslOverIma_E))

{

E1Port = 8;

/* setup connections for each vpi at the existing ports */

for (int port=0 ; port<num_of_adsl_ports ; port++)

{

for(int vpi=0 ; vpi < num_vpi_per_port ; vpi++)

{
/* setup the lc for the upstream connection: */

/* lci[13:0] = vpi * 16 + port[4:0] */
/* the lci is the address for the upstream_eci and all other params */
lci = (vpi << 4) | port ;
upstream_eci = lci;
/* Setup the upstream connection */
ACI_AspSetConUpPP_F(true, /* valid_con */

lci,
upstream_eci,
ASP_RA_FOR_CSM,
false, /* multicast_en */
true, /* enable_plane_0 */
false, /* enable_plane_1 */
false, /* enable_iCLP */
ACI_ASP_high_pri_E );

downstream_eci = upstream_eci;

| | |
|---|---|
| // | downstream_vpi = (port<<4)\|vpi; |

downstream_vpi = (port<<3)|vpi;

ACI_AspSetConDownPP_F(true,/* valid_con */

downstream_eci,

downstream_vpi,/*lci=vpi at the downstream direction */

active_plane,
E1Port,
true);/* discard_fcs2_err_cell */

| | |
|---|---|
| // | upstream_vpi = (port<<4)\|vpi; |

upstream_vpi = (port<<3)|vpi;
lci = ( upstream_vpi<<4) | E1Port ;
upstream_eci = lci;

ACI_AspSetConUpPP_F(true, /* valid_con */

lci,
upstream_eci,
ASP_RA_FOR_CSM,
false, /* multicast_en */
true, /* enable_plane_0 */
false, /* enable_plane_1 */
false, /* enable_iCLP */
ACI_ASP_high_pri_E );

downstream_eci = upstream_eci;

| | |
|---|---|
| // | modified_downstream_vpi = vpi & 0×000F; |

modified_downstream_vpi = vpi & 0×0007;

ACI_AspSetConDownPP_F( true,/* valid_con */

downstream_eci,

modified_downstream_vpi ,/*lci=vpi at the downstream direction */

active_plane,
port,
true);/* discard_fcs2_err_cell */

}

}

}

}

In another embodiment, the method and operations described above are employed for provisioning SoftPVCs. For SoftPVC connections the system described above further simplifies the ADSL card software.

It is understood that other algorithms may be used to implement automatic provisioning of ATM connections and the above algorithm is not meant to be limiting in any way.

### CONCLUSION

Although specific embodiments have been illustrated and described herein, it will be appreciated by those of ordinary skill in the art that any arrangement, which is calculated to achieve the same purpose, may be substituted for the specific embodiments shown. For example, although embodiments of the present invention have been described with respect to ADSL technologies, it is understood that other DSL technologies are also covered by this specification. This application is intended to cover any adaptations or variations of the present invention. Therefore, it is intended that this invention be limited only by the claims and the equivalents thereof.

What is claimed is:

1. A digital subscriber line interface card, comprising:
a digital subscriber line interface adapted to receive asynchronous transfer mode (ATM) traffic from one or more digital subscriber lines;
a translation device coupled to the digital subscriber line interface wherein the translation device is programmed to statically cross connect the ATM traffic between customer premises equipment and a network;
wherein the translation device cross connects customer premises equipment based on the physical port number the ATM traffic is received at and the number of virtual path identifiers assigned to the customer premises equipment; and
an inverse multiplexer adapted to receive and map the ATM traffic directly onto one or more time division multiplex transmission lines.

2. The digital subscriber line interface card of claim 1, further comprising a splitter coupled between the digital subscriber line interface and the customer premises equipment, wherein the splitter separates asynchronous transfer mode traffic from plain old telephone service traffic.

3. The digital subscriber line interface card of claim 1, wherein the translation device is an application specific integrated chip.

4. The digital subscriber line interface card of claim 1, wherein the translation device includes a storage medium.

5. The digital subscriber line interface card of claim 1, wherein the one or more time division multiplex transmission lines comprise one or more T1 lines.

6. The digital subscriber line interface card of claim 1, wherein the storage medium is a random access memory device.

7. A remote unit, comprising:
one or more digital subscriber line interface cards, including:
a digital subscriber line interface adapted to receive asynchronous transfer mode (ATM) traffic from one or more digital subscriber lines;
an application specific integrated circuit coupled to the digital subscriber line interface and programmed to statically cross connect the ATM traffic between customer premises equipment to a network;
wherein the application specific integrated circuit device cross connects customer premises equipment based on the physical port number that receives the ATM traffic and the number of virtual path identifiers assigned to the customer premises equipment; and
an inverse multiplexer adapted to receive and map the ATM traffic directly onto one or more time division multiplex transmission lines; and
an internal TDM bus coupled between the one or more digital subscriber line interface cards and a TDM network.

8. The remote unit of claim 7, further comprising:
one or more plain old telephone service cards coupled to the internal TDM bus.

9. The remote unit of claim 7, further comprising:
one or more ISDN cards a coupled to the internal TDM bus.

10. The remote unit of claim 7, wherein the one or more digital subscriber line interface cards further comprise a splitter coupled between the digital subscriber line interface and the customer premises equipment, wherein the splitter separates ATM traffic from plain old telephone service traffic.

11. The remote unit of claim 7, wherein the application specific integrated circuit includes a storage medium.

12. The remote unit of claim 7, wherein the one or more time division multiplex transmission lines comprise one or more T1 lines.

13. An asymmetric digital subscriber line interface card, comprising:
an asymmetric digital subscriber line (ADSL) interface device;
a translation device coupled to the asymmetric digital subscriber line interface device;
wherein the translation device performs a virtual path cross connect function between customer premises equipment and a network;
wherein the virtual path cross connect function is based on a physical port number that receives the asynchronous mode traffic and a virtual path identifier assigned to the customer premises equipment;
an inverse multiplexer coupled to the asymmetric digital subscriber line interface device, wherein the inverse multiplexer directly maps the asynchronous transfer mode traffic directly to one or more time division multiplex transmission lines; and
a time division multiplex interface coupled to the inverse multiplexer.

14. The interface card of claim 13, further comprising a storage medium coupled to the translation device.

15. The interface card of claim 13, further comprising a splitter coupled between the asymmetric digital subscriber line interface device and the customer premises equipment, wherein the splitter separates ATM traffic from plain old telephone service traffic.

16. The interface card of claim 13, wherein the translation device comprises an application specific integrated circuit.

17. The interface card of claim 13, wherein the one or more time division multiplex transmission lines comprise one or more T1 lines.

18. An asymmetric digital subscriber line interface card, comprising:
a splitter;
an asymmetric digital subscriber line interface device coupled to the splitter, wherein the ADSL device is adapted to receive asynchronous transfer mode (ATM) traffic from one or more customer premises equipment;
wherein the splitter separates the ATM traffic from plain old telephone service (POTS) traffic;
a POTS line termination circuit coupled to the splitter;
a translation device coupled to the asymmetric digital subscriber line interface device, wherein the translation device cross connects the ATM traffic between the customer premises equipment and a network based on a virtual path identifier of the traffic and the port number that the traffic was received at;
an inverse multiplexer coupled to the asymmetric digital subscriber line interface device;
a time division multiplex interface coupled to the inverse multiplexer; and
wherein the inverse multiplexer directly maps ATM traffic onto one or more time division multiplex transmission lines.

19. The interface card of claim 18, wherein the translation device is an application specific integrated circuit.

20. The interface card of claim 18, wherein the translation device includes a storage device.

21. The interface card of claim 20, wherein the storage device is a random access memory device.

22. An asymmetric digital subscriber line (ADSL) interface card, comprising:
an asymmetric digital subscriber line interface device, wherein the ADSL device is adapted to receive ATM traffic from one or more ADSLs;
a plurality of ports adapted to receive the ATM traffic from the one or more ADSLs, wherein each port includes one or more physical ports (PHYS);
a UTOPIA interface;
a translation device adapted to receive ATM traffic from the one or more PHYs over the UTOPIA interface, wherein the translation device cross connects the ATM traffic between customer premises equipment and an ATM network based on the PHY that receives the ATM traffic and a VPI assigned to the traffic; and
an inverse multiplexer coupled to the asymmetric digital subscriber line interface device, wherein the inverse multiplexer directly maps ATM traffic onto one or more time division multiplex transmission lines.

23. The interface card of claim 22, wherein the translation device is an application specific integrated circuit.

24. The interface card of claim 22, wherein the translation device includes a storage device.

25. The interface card of claim 24, wherein the storage device is a random access memory device.

26. A telecommunications network, comprising:
one or more remote units, wherein at least one of the one or more remote units includes:
at least one ADSL interface card that maps ATM traffic directly onto one or more TDM transmission lines;
a translation device that cross connects the ATM traffic between customer premises and a network based on a virtual path identifier of the ATM traffic and the port number that the traffic was received on; and
a central unit coupled to the one or more remote units over a TDM network.

27. The telecommunications network of claim 26, wherein the translation device is an application specific integrated circuit.

28. The telecommunications network of claim 26, wherein the translation device includes a storage device.

29. The telecommunications network of claim 28, wherein the storage device is a random access memory device.

30. A method of provisioning asynchronous transfer mode traffic, the method comprising:
receiving upstream asynchronous transfer mode (ATM) data from customer premises equipment;
detecting the port number at which the upstream ATM data is received;
reading a first virtual path identifier (VPI) number from the header information of the upstream ATM data;
acquiring a new VPI number for the upstream ATM traffic based on the receiving port number and the first VPI number;
attaching the new VPI number to the upstream ATM traffic; and
directly mapping the ATM traffic onto one or more TDM transmission lines.

31. The method of claim 30, wherein acquiring a new VPI number comprises:
retrieving the new VPI number from a look-up table using the first VPI number and the receiving port number.

32. The method of claim 31, wherein retrieving the new VPI number comprises using a memory pointer comprising the first VPI number and the receiving port number.

33. The method of claim 30, wherein acquiring a new VPI number comprises:
calculating a new VPI number based on the first VPI and the receiving port number.

34. The method of claim 33, further comprising recording the new VPI number in a look up table.

35. A method of provisioning asynchronous transfer mode (ATM) traffic, comprising:
receiving downstream ATM traffic over one or more TDM transmission lines;
detecting a first VPI number from the header information of the downstream ATM traffic;
retrieving a second VPI number and a port number for the ATM traffic from a look-up table based on the first VPI number; and
attaching the second VPI number to the received downstream ATM traffic; and
mapping the received downstream ATM traffic to the appropriate customer premises equipment based on the second VPI number and port number.
